(19) United States
(12) Patent Application Publication
(10) Pub. No.: US 2026/0349242 A1
(43) Pub. Date: Nov. 5, 2026

(54) REFLECTION MODULE

(71) Applicant: SAMSUNG ELECTRO-MECHANICS CO., LTD., Suwon-si (KR)

(72) Inventors: Hyun Jun KIM, Suwon-si (KR); Young Bok YOON, Suwon-si (KR); Jae Hyung HAN, Suwon-si (KR)

(73) Assignee: SAMSUNG ELECTRO-MECHANICS CO., LTD., Suwon-si (KR)

(21) Appl. No.: 19/417,809

(22) Filed: Dec. 12, 2025

(30) Foreign Application Priority Data
Apr. 30, 2025 (KR) 10-2025-0057164

(51) Int. Cl. G02B 26/08; G03B 5/06

(52) U.S. Cl. CPC G02B 26/0816; G03B 5/06; G03B 2205/0023; G03B 2205/0069

(57) ABSTRACT

A reflection module includes a housing, a holder rotatably disposed with respect to the housing, a reflective member fixed to the holder, a support portion disposed between the housing and the holder, and supporting the holder, a first magnetic body portion disposed in the holder, and including a first magnet and a second magnet, and a second magnetic body portion disposed in the housing, and including a third magnet and a fourth magnet, wherein attractive force acts between the first magnet and the third magnet, and between the second magnet and the fourth magnet, respectively, and a polarity of one surface of the first magnet and a polarity of one surface of the second magnet are opposite to each other, and a polarity of one surface of the third magnet and a polarity of one surface of the fourth magnet are opposite to each other.

### CROSS-REFERENCE TO RELATED APPLICATIONS

This application claims the benefit under 35 USC 119(a) of Korean Patent Application No. 10-2025-0057164 filed on Apr. 30, 2025, in the Korean Intellectual Property Office, the entire disclosure of which is incorporated herein by reference for all purposes.

### BACKGROUND

### 1. Field

The present disclosure relates to a reflection module.

### 2. Description of the Background

Recently, a camera module which bends a travelling path of light by disposing a reflection module in front of a lens module is being adopted in a mobile device. The reflection module has a reflective member reflecting light.

In addition, the camera module has an optical image stabilization function which corrects shaking during image capturing to increase resolution. Such an optical image stabilization function may be implemented through a two-axis rotation of the reflective member provided in the reflection module.

However, the conventional reflection module has the problem of having a complex structure for implementing the two-axis rotation of the reflective member.

In addition, there is a problem in which the reflective member is tilted to one side when power is not supplied to the reflection module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a reflection module includes a housing, a holder rotatably disposed with respect to the housing, a reflective member fixed to the holder, a support portion disposed between the housing and the holder, and supporting the holder so that the holder is rotatable in a plurality of directions, a first magnetic body portion disposed in the holder, and including a first magnet and a second magnet, disposed to be spaced apart from each other, and a second magnetic body portion disposed in the housing, and including a third magnet and a fourth magnet, disposed to be spaced apart from each other, wherein attractive force acts between the first magnet and the third magnet, and between the second magnet and the fourth magnet, respectively, a polarity of one surface of the first magnet and a polarity of one surface of the second magnet are opposite to each other, and a polarity of one surface of the third magnet and a polarity of one surface of the fourth magnet are opposite to each other.

A direction in which the first magnet and the second magnet are spaced apart from each other and a direction in which the third magnet and the fourth magnet are spaced apart from each other may be the same.

A distance between a center of the first magnet and a center of the second magnet may be less than a distance between a center of the third magnet and a center of the fourth magnet.

A portion of the first magnetic body portion and a portion of the second magnetic body portion may face each other in one direction, and when viewed in the one direction, the first magnetic body portion may be closer to the support portion than the second magnetic body portion.

A portion of the one surface of the first magnet and a portion of the one surface of the third magnet may face each other, and a portion of the one surface of the second magnet and a portion of the one surface of the fourth magnet may face each other.

The third magnet may be disposed to overlap less than half a width of the one surface of the first magnet in one direction, and the fourth magnet may be disposed to overlap less than half the width of the one surface of the second magnet in the one direction.

The polarity of the one surface of the first magnet and the polarity of the one surface of the fourth magnet may be the same polarities, and the polarity of the one surface of the second magnet and the polarity of the one surface of the third magnet may be the same polarities.

The first to fourth magnets respectively may have curved inner and outer surfaces.

A length of the third magnet may be longer than a length of the first magnet, and a length of the fourth magnet may be longer than a length of the second magnet.

An area of the one surface of the third magnet may be greater than an area of the one surface of the first magnet, and an area of the one surface of the fourth magnet may be greater than an area of the one surface of the second magnet.

The inner surface of the first magnet, the outer surface of the first magnet, the inner surface of the third magnet, and the outer surface of the third magnet may be portions of concentric circles when viewed in one direction, and the inner surface of the second magnet, the outer surface of the second magnet, the inner surface of the fourth magnet, and the outer surface of the fourth magnet may be portions of concentric circles when viewed in the one direction.

The reflection module may further include a first driving unit disposed in the housing, and comprising a first coil and a second coil, wherein a direction in which the first coil and the second coil are spaced apart from each other may be perpendicular to a direction in which the third magnet and the fourth magnet are spaced apart from each other.

The first coil and the second coil may be wound to have a thickness in a direction toward the holder, respectively.

The third magnet and the fourth magnet may be respectively disposed on an inner surface of the housing, and the first coil and the second coil may be respectively disposed on the inner surface of the housing.

The first coil may be disposed between one side of the third magnet and one side of the fourth magnet, and the second coil may be disposed between the other side of the third magnet and the other side of the fourth magnet.

The first coil and the second coil respectively may have curved inner and outer surfaces.

Other features and aspects will be apparent from the following detailed description, the drawings, and the claims.

### BRIEF DESCRIPTION OF DRAWINGS

FIG. 1 is a side view of a reflection module according to an embodiment of the present disclosure.

FIG. 2 is a rear view of a reflection module according to an embodiment of the present disclosure.

FIG. 3 is a plan view of a reflection module according to an embodiment of the present disclosure.

FIG. 4 is a side view of a reflection module according to another embodiment of the present disclosure.

FIG. 5 is a rear view of a reflection module according to another embodiment of the present disclosure.

FIG. 6 is a plan view of a reflection module according to another embodiment of the present disclosure.

FIG. 7 is a side view of a reflection module according to another embodiment of the present disclosure.

FIG. 8 is a rear view of a reflection module according to another embodiment of the present disclosure.

FIG. 9 is a plan view of a reflection module according to another embodiment of the present disclosure.

FIG. 10 is a side view of a reflection module, illustrating a driving unit of a reflection module according to an embodiment of the present disclosure.

FIG. 11 is a rear view of FIG. 10.

FIG. 12 is a plan view of FIG. 10.

FIGS. 13A-13C are diagrams, illustrating a driving unit of a reflection module according to an embodiment of the present disclosure.

FIG. 14 is a side view of a reflection module, illustrating a modified example of a first driving unit 600.

FIGS. 15A-15C are diagrams, illustrating a modified example of the first driving unit.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Any component included in an embodiment of the embodiments disclosed herein may also be included in other embodiments unless stated otherwise.

An aspect of the present disclosure is to provide a reflection module that can simplify a rotational structure of a reflective member and which can adjust a position of the reflective member when power is not supplied thereto.

The present disclosure relates to a reflection module, and the reflection module may be configured to be mounted on a camera module. In addition, the camera module may be mounted on a portable electronic device such as a mobile communication terminal, a smartphone, a tablet PC, or the like.

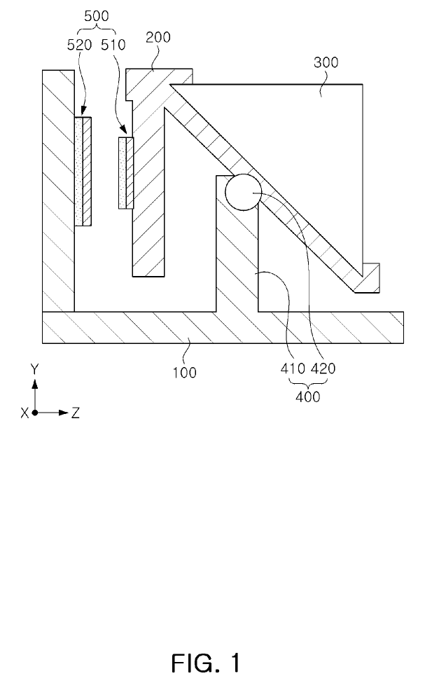

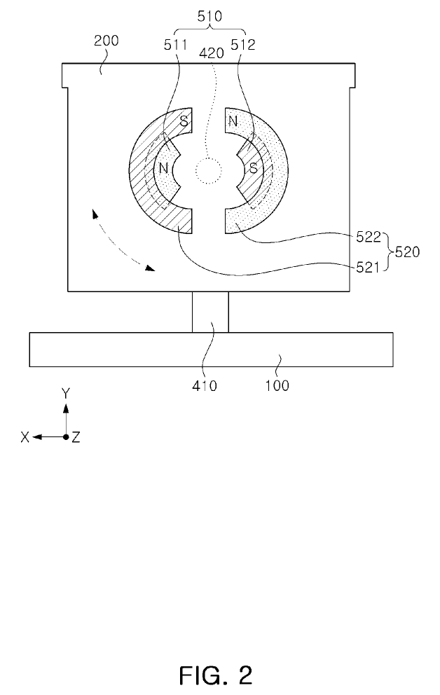

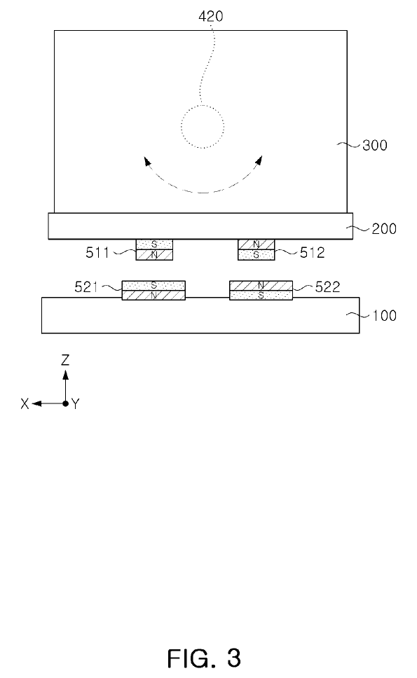

FIG. 1 is a side view of a reflection module according to an embodiment of the present disclosure, FIG. 2 is a rear view of a reflection module according to an embodiment of the present disclosure, and FIG. 3 is a plan view of a reflection module according to an embodiment of the present disclosure.

Referring to FIGS. 1-3, a reflection module according to an embodiment of the present disclosure includes a housing 100, a holder 200, and a reflective member 300.

The reflective member 300 has a reflective surface reflecting light. For example, the reflective member 300 may be a prism or a mirror. The reflective member 300 may be coupled to the holder 200.

The reflective member 300 may be rotatable in a plurality of directions for optical image stabilization. In an embodiment, the reflective member 300 may be rotatably disposed around at least two different axes. For example, the reflective member 300 may be rotatable around two axes perpendicular to each other.

The reflective member 300 may be rotated together with the holder 200. The reflective member 300 and the holder 200 are accommodated in the housing 100. In an embodiment, the housing 100 may be a component of a reflection module. However, it may be configured in a form in which the reflective member 300 and the holder 200 are accommodated in the housing of the camera module.

The reflection module further includes a support portion 400 which rotatably supports the holder 200. The support portion 400 may be provided in a hinge structure. In an embodiment, the support portion 400 may include a ball member 420 and a support protrusion 410. The support protrusion 410 may be extended from the housing 100, and the ball member 420 is coupled to the support protrusion 410 to rotatably support the holder 200. A groove into which the ball member 420 is inserted may be formed in the holder 200. In another embodiment, a structure in which the support protrusion 410 is formed in the holder 200 and the groove into which the ball member 420 is inserted is formed in the housing 100 is also possible.

In an embodiment, a structure in which the ball member 420 is not coupled to the support protrusion 410, and a structure in which the end of the support protrusion 410 is formed into a curved surface is also possible.

In an embodiment, a first lens module may be disposed in front of the reflection module.

The first lens module includes at least one lens, and an axis extending an optical axis of the first lens module in an optical axis direction may pass through the support portion 400. For example, the axis extending the optical axis of the first lens module in the optical axis direction may pass through the ball member 420 of the support portion 400.

The first lens module may be coupled to a reflection module. For example, the first lens module may be coupled to a holder 200 of the reflection module. Accordingly, the first lens module may be rotated together with the holder 200.

In an embodiment, a second lens module may be disposed at the rear of the reflection module.

The second lens module includes a plurality of lenses, and an axis extending an optical axis of the second lens module in an optical axis direction may pass through the support portion 400. For example, the axis extending the optical axis of the second lens module in the optical axis direction may pass through the ball member 420 of the support portion 400.

The optical axis of the first lens module and the optical axis of the second lens module may be formed perpendicular to each other.

The first lens module and the reflective member 300 may be configured to be rotated together for optical image stabilization. The second lens module may be moved in the optical axis of the second lens module for focusing.

A reflection module according to an embodiment of the present disclosure may form a camera module together with at least one of a first lens module and a second lens module.

The camera module may further include an image sensor module. The image sensor module may be disposed at the rear of the second lens module. When the camera module does not include the second lens module, the image sensor module may be disposed at the rear of the reflection module.

A reflection module 300 has an incident surface on which light is incident, a reflective surface from which light is reflected, and an emission surface from which light is emitted.

The reflective member 300 is mounted on a holder 200. The holder 200 is rotatably disposed in the housing 100. For example, the holder 200 may be rotated with the ball member 420 of the support portion 400 as a center of rotation. The reflective member 300 may be rotated together with the holder 200.

In an embodiment, the holder 200 may be rotated with respect to the housing 100 around a first rotational axis (Z-axis). The holder 200 may be rotated with respect to the housing 100 around a second rotational axis (X-axis). The first rotational axis (Z-axis) and the second rotational axis (X-axis) may be perpendicular to each other.

The first rotational axis (Z-axis) may be an axis perpendicular to an emission surface. The first rotational axis (Z-axis) may be an axis parallel to an incident surface. The second rotational axis (X-axis) may be an axis parallel to both the incident surface and the emission surface.

Hereinafter, the direction perpendicular to the emission surface is referred to as a first rotational axis (Z-axis) direction, and the direction parallel to both the incident surface and the emission surface is referred to as a second rotational axis (X-axis) direction.

The reflection module may further include a magnetic portion 500. Magnetic force may act between the housing 100 and the holder 200 by the magnetic portion 500. The magnetic portion 500 includes a first magnetic body portion 510 and a second magnetic body portion 520.

The first magnetic body portion 510 may be mounted on the holder 200, and the second magnetic body portion 520 may be mounted on the housing 100. The first magnetic body portion 510 and the second magnetic body portion 520 may face each other in a first rotational axis (Z-axis) direction.

The first magnetic body portion 510 includes a first sub-magnetic body 511 and a second sub-magnetic body 512, disposed to be spaced apart from each other. The first sub-magnetic body 511 and the second sub-magnetic body may be disposed to be spaced apart in a direction perpendicular to the first rotational axis (Z-axis) direction (e.g., in the second rotational axis (X-axis) direction).

The first sub-magnetic body 511 and the second sub-magnetic body 512 may respectively be magnets. In this case, the first sub-magnetic body 511 may be referred to as a first magnet, and the second sub-magnetic body 512 may be referred to as a second magnet.

One surface of the first sub-magnetic body 511 and one surface of the second sub-magnetic body 512 may be configured to have opposite polarities.

The first sub-magnetic body 511 may be configured to have one surface facing the second magnetic body portion 520 to have an N-pole or an S-pole. When the one surface of the first sub-magnetic body 511 has an N-pole, the one surface of the second sub-magnetic body 512 facing the second magnetic body portion 520 may be configured to have an S-pole. When the one surface of the first sub-magnetic body 511 has an S-pole, one surface of the second sub-magnetic body 512 facing the second magnetic body portion 520 may be configured to have an N-pole.

The second magnetic body 520 includes a third sub-magnetic body 521 and a fourth sub-magnetic body 522 disposed to be spaced apart from each other. The third sub-magnetic body 521 and the fourth sub-magnetic body 522 may be disposed to be spaced apart in a direction perpendicular to the first rotational axis (Z-axis) direction (e.g., in the second rotational axis (X-axis) direction).

The third sub-magnetic body 521 and the fourth sub-magnetic body 522 may respectively be magnets. In this case, the third sub-magnetic body 521 may be referred to as a third magnet, and the fourth sub-magnetic body 522 may be referred to as a fourth magnet.

One surface of the third sub-magnet body 521 and one surface of the fourth sub-magnet body 522 may be configured to have opposite polarities.

The third sub-magnetic body 521 may be configured to have one surface facing the first magnetic body portion 510 to have an S-pole or an N-pole. When the one surface of the third sub-magnetic body 521 has an S-pole, the one surface of the fourth sub-magnetic body 522 facing the first magnetic body portion 510 may be configured to have an N-pole. When the one surface of the third sub-magnetic body 521 has an N-pole, the one surface of the fourth sub-magnetic body 522 facing the first magnetic body portion 510 may be configured to have an S-pole.

At least a portion of the one surface of the first sub-magnetic body 511 and at least a portion of the one surface of the third sub-magnetic body 521 may face each other in a first rotational axis (Z-axis) direction. A polarity of the one surface of the first sub-magnetic body 511 and a polarity of the one surface of the third sub-magnetic body 521 may be opposite to each other. Therefore, attractive force acts between the first sub-magnetic body 511 and the third sub-magnetic body 521.

When viewed in the first rotational axis (Z-axis) direction, the third sub-magnetic body 521 may be disposed to overlap a portion of the first sub-magnetic body 511. For example, the third sub-magnetic body 521 may be disposed to cover less than half of a width of one surface of the first sub-magnetic body 511.

At least a portion of the one surface of the second sub-magnetic body 512 and at least a portion of the one surface of the fourth sub-magnetic body 522 may face each other in the first rotational axis (Z-axis) direction. A polarity of the one surface of the second sub-magnetic body 512 and a polarity of the one surface of the fourth sub-magnetic body 522 may be opposite to each other. Therefore, attractive force acts between the second sub-magnetic body 512 and the fourth sub-magnetic body 522.

When viewed in the first rotational axis (Z-axis) direction, the fourth sub-magnetic body 522 may be disposed to overlap a portion of the second sub-magnetic body 512. For example, the fourth sub-magnetic body 522 may be disposed to cover less than half of a width of one surface of the second sub-magnetic body 512.

A distance between a center of the first sub-magnetic body 511 and a center of the second sub-magnetic body 512 may be narrower than a distance between a center of the third sub-magnetic body 521 and a center of the fourth sub-magnetic body 522.

In an embodiment, a distance between the center of the first sub-magnetic body 511 and the center of the second sub-magnetic body 512 in a second rotational axis (X-axis) direction may be narrower than a distance between the center of the third sub-magnetic body 521 and the center of the fourth sub-magnetic body 522 in the second rotational axis (X-axis) direction.

When viewed in the first rotational axis (Z-axis) direction, the first sub-magnetic body 511 and the second sub-magnetic body 512 may be disposed closer to a support portion 400 (e.g., a ball member 420) than the third sub-magnet body 521 and the fourth sub-magnet body 522.

The first sub-magnetic body 511 to the fourth sub-magnetic body 522 may respectively have rounded shapes. For example, the first sub-magnetic body 511 to the fourth sub-magnetic body 522 may respectively have rounded shapes when viewed in the first rotational axis (Z-axis) direction.

In an embodiment, the first sub-magnetic body 511 has an inner surface and an outer surface, and the inner surface and the outer surface may respectively have curved shapes. Here, the inner surface may be a surface facing a center of rotation of the holder 200 when viewed in the first rotational axis (Z-axis), and the outer surface may be an opposite surface of the inner surface. In addition, the inner surface of the first sub-magnetic body 511 may mean a surface adjacent to the second sub-magnetic body 512.

The first sub-magnetic body 511 may be formed so that a length of the outer surface is longer than a length of the inner surface.

The second sub-magnetic body 512 has the same shape as the first sub-magnetic body 511, and the first sub-magnetic body 511 and the second sub-magnetic body 512 may be disposed in symmetrical positions with respect to the center of rotation of the holder 200.

A length of the third sub-magnet body 521 may be longer than the length of the first sub-magnet body 511.

The third sub-magnetic body 521 has an inner surface and an outer surface, and the inner surface and the outer surface may respectively have curved shapes. Here, the inner surface may be a surface facing a center of rotation of the holder 200 when viewed in the first rotational axis (Z-axis), and the outer surface may be an opposite surface of the inner surface. The length of the inner surface of the third sub-magnetic body 521 is longer than the length of the inner surface of the first sub-magnetic body 511. In addition, the length of the outer surface of the third sub-magnetic body 521 is longer than the length of the outer surface of the first sub-magnetic body 511.

The fourth sub-magnetic body 522 has the same shape as the third sub-magnetic body 521, and the third sub-magnetic body 521 and the fourth sub-magnetic body 522 may be disposed in symmetrical positions with respect to the center of rotation of the holder 200.

When viewed in a first rotational axis (Z-axis) direction, an outer surface of the first sub-magnetic body 511 may be located between the outer surface and the inner surface of the third sub-magnetic body 521. That is, when viewed in the first rotational axis (Z-axis) direction, the third sub-magnetic body 521 may overlap a portion of the first sub-magnetic body 511.

The inner surface of the first sub-magnetic body 511, the outer surface of the first sub-magnetic body 511, the inner surface of the third sub-magnetic body 521, and the outer surface of the third sub-magnetic body 521 may respectively be portions of concentric circles when viewed in the first rotational axis (Z-axis) direction.

The inner surface of the second sub-magnetic body 512, the outer surface of the second sub-magnetic body 512, the inner surface of the fourth sub-magnetic body 522, and the outer surface of the fourth sub-magnetic body 522 may respectively be portions of concentric circles when viewed in the first rotational axis (Z-axis) direction.

An area of the one surface of the third sub-magnetic body 521 is greater than an area of the one surface of the first sub-magnetic body 511, and an area of the one surface of the fourth sub-magnetic body 522 is greater than an area of the one surface of the second sub-magnetic body 512.

Referring to FIG. 1, the holder 200 may be rotated around the second rotational axis (X-axis) to correct shaking. For example, the reflection module may further include a driving unit, and the holder 200 may be rotated around the second rotational axis (X-axis) by the driving force of the driving unit.

Even if the power to the driving unit is turned off and the driving force is removed, attractive force may act between the first magnetic body portion 510 and the second magnetic body portion 520, and such attractive force may act as a return torque to return the holder 200 to an initial position thereof. Here, the initial position may mean a state in which the first magnetic body portion 510 and the second magnetic body portion 520 are parallel, or a state in which the lower surface of the holder 200 and the bottom surface of the housing 100 are parallel.

Referring to FIG. 2, the holder 200 may be rotated around the first rotational axis (Z-axis) to correct shaking. For example, the holder 200 may be rotated around the first rotational axis (Z-axis) by the driving force of the driving unit.

When the holder 200 rotates around the first rotational axis (Z-axis), the first sub-magnetic body 511 and the fourth sub-magnetic body 522 become closer to each other, and the second sub-magnetic body 512 and the third sub-magnetic body 521 also become closer to each other.

That is, when the holder 200 rotates around the first rotational axis (Z-axis), a distance between magnetic bodies having the same polarity becomes closer, so strong repulsive force may act. Therefore, such repulsive force may act as a return torque to return the holder 200 to the initial position.

Referring to FIG. 3, when the holder 200 is to be rotated around an axis, which is perpendicular to both the first rotational axis (Z-axis) and the second rotational axis (X-axis), the attractive force acting between the first sub-magnetic body 511 and the third sub-magnetic body 521 and the repulsive force acting between the first sub-magnetic body 511 and the fourth sub-magnetic body 522 may act as a return torque which impedes the rotation of the holder 200, respectively.

That is, since both magnetic force acting between the first sub-magnetic body 511 and the third sub-magnetic body 521 and magnetic force acting between the first sub-magnetic body 511 and the fourth sub-magnetic body 522 act as a return torque on the holder 200, the holder 200 may be strongly suppressed from rotating around an axis, perpendicular to both the first rotational axis (Z-axis) and the second rotational axis (X-axis). Meanwhile, the attractive force acting between the second sub-magnetic body 512 and the fourth sub-magnetic body 522 and the repulsive force acting between the second sub-magnetic body 512 and the third sub-magnetic body 521 may also act as a return torque.

Therefore, even if the holder 200 is disposed in a state in which the holder 200 may mechanically rotate freely with respect to the housing 100, the holder 200 may be prevented from rotating in any direction by the magnetic force acting between the first magnetic body portion 510 and the second magnetic body portion 520.

In addition, since a predetermined return torque may be applied to the holder 200 when the power of the driving unit is turned off, the position of the holder 200 may be adjusted without separate power consumption when shake correction is not required (e.g., when power is not supplied to the driving unit).

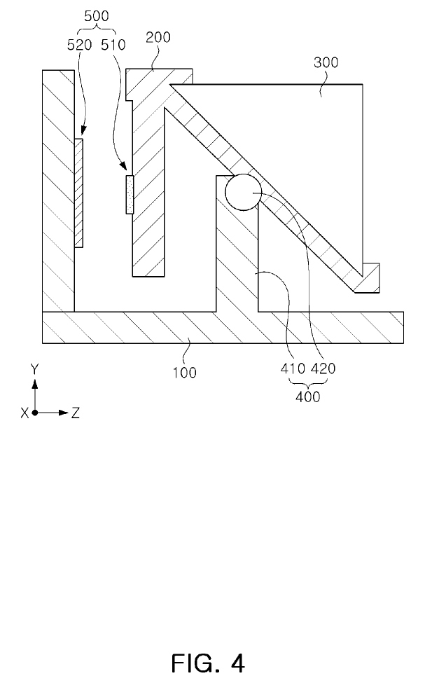

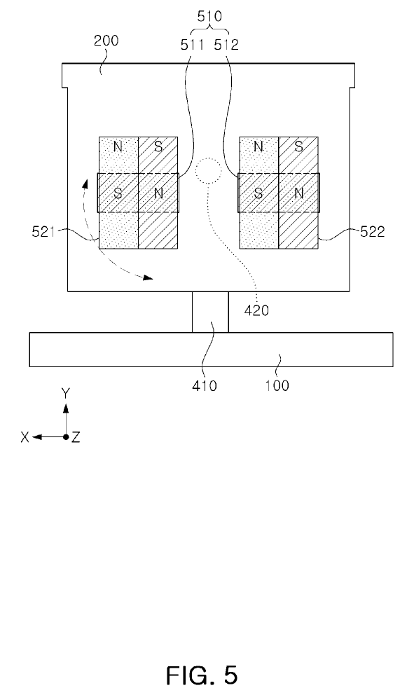

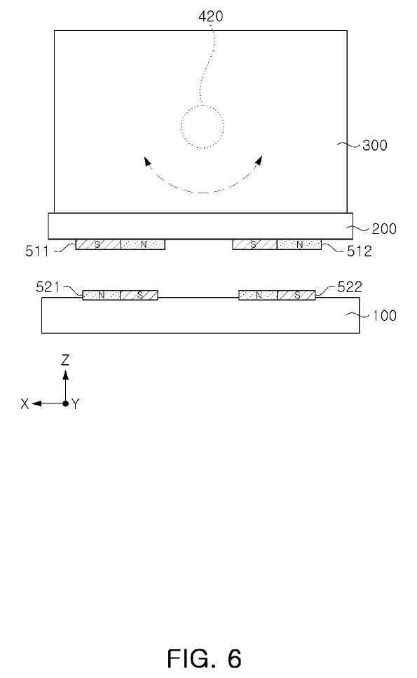

FIG. 4 is a side view of a reflection module according to another embodiment of the present disclosure, FIG. 5 is a rear view of a reflection module according to another embodiment of the present disclosure, and FIG. 6 is a plan view of a reflection module according to another embodiment of the present disclosure.

Referring to FIGS. 4-6, there is a difference in the configurations of a magnetic portion 500 from the previously described embodiment.

The magnetic portion 500 includes a first magnetic body portion 510 and a second magnetic body portion 520.

The first magnetic body portion 510 may be mounted on the holder 200, and the second magnetic body portion 520 may be mounted on the housing 100. The first magnetic body portion 510 and the second magnetic body portion 520 may face each other in a first rotational axis (Z-axis) direction.

The first magnetic body portion 510 includes a first sub-magnetic body 511 and a second sub-magnetic body 512. The first sub-magnetic body 511 and the second sub-magnetic body 512 may be disposed to be spaced apart in a direction perpendicular to the first rotational axis (Z-axis) direction (e.g., in a second rotational axis (X-axis) direction).

The first sub-magnetic body 511 and the second sub-magnetic body 512 may respectively be magnets.

One surface of the first sub-magnetic body 511 may be configured to have both an N-pole and an S-pole. The N-pole and the S-pole may be disposed to be spaced apart or side-by-side in a direction perpendicular to the first rotational axis (Z axis) direction (e.g., in a second rotational axis (X-axis) direction) on the one surface of the first sub-magnet body 511.

One surface of the second sub-magnetic body 512 may be configured to have both an N-pole and an S-pole. The N-pole and the S-pole may be disposed to be spaced apart or side-by-side in a direction perpendicular to the first rotational axis (Z axis) direction (e.g., in the second rotational axis (X-axis) direction) on the one surface of the second sub-magnet body 512.

One surface of the first sub-magnet body 511 and one surface of the second sub-magnet body 512 may be configured to have different polarities in portions close to each other. For example, when one surface of the first sub-magnetic body 511 has an S-pole on a side, farther from the second sub-magnetic body 512, and an N-pole on a side, closer to the second sub-magnetic body 512, one surface of the second sub-magnetic body 512, which is closer to the first sub-magnetic body 511 may have an S-pole and one surface thereof, which is farther from the first sub-magnetic body 511 may have an N-pole.

The second magnetic body 520 includes a third sub-magnetic body 521 and a fourth sub-magnetic body 522. The third sub-magnetic body 521 and the fourth sub-magnetic body 522 may be disposed to be spaced apart in a direction perpendicular to the first rotational axis (Z-axis) direction (e.g., in a second rotational axis (X-axis) direction).

The third sub-magnetic body 521 and the fourth sub-magnetic body 522 may respectively be magnets.

One surface of the third sub-magnetic body 521 may be configured to have both an N-pole and an S-pole. The N-pole and the S-pole may be disposed to be spaced apart or side-by-side in a direction perpendicular to the first rotational axis (Z axis) direction (e.g., in a second rotational axis (X-axis) direction) on the one surface of the third sub-magnet body 521.

One surface of the fourth sub-magnet body 522 may be configured to have both an N-pole and an S-pole. The N-pole and the S-pole may be disposed to be spaced apart or side-by-side in a direction perpendicular to the first rotational axis (Z axis) direction (e.g., in a second rotational axis (X-axis) direction) on one surface of the fourth sub-magnet body 522.

One surface of the third sub-magnet body 521 and one surface of the fourth sub-magnetic body 522 may be configured to have different polarities in portions close to each other. For example, when one surface of the third sub-magnetic body 521 has an N-pole on a side, farther from the fourth sub-magnetic body 522, and an S-pole on a side, closer to the fourth sub-magnetic body 522, one surface of the fourth sub-magnetic body 522, which is closer to the third sub-magnetic body 521 may have an N-pole and one surface thereof, which is farther from the first sub-magnetic body 511 may have an S-pole.

At least a portion of one surface of the first sub-magnetic body 511 and at least a portion of one surface of the third sub-magnetic body 521 may face each other in the first rotational axis (Z-axis) direction. The first sub-magnetic body 511 and the third sub-magnetic body 513 may be disposed so that opposite polarities thereof face each other. Therefore, attractive force acts between the first sub-magnetic body 511 and the third sub-magnetic body 521.

At least a portion of one surface of the second sub-magnetic body 512 and at least a portion of one surface of the fourth sub-magnetic body 522 may face each other in the first rotational axis (Z-axis) direction. The second sub-magnetic body 512 and the fourth sub-magnetic body 522 may be disposed so that opposite polarities thereof face each other. Therefore, attractive force acts between the second sub-magnetic body 512 and the fourth sub-magnetic body 522.

A distance between the first sub-magnetic body 511 and the second sub-magnetic body 511 in a second rotational axis (X-axis) direction may be narrower than a distance between the third sub-magnetic body 521 and the fourth sub-magnetic body 522 in the second rotational axis (X-axis) direction.

A length direction of the first sub-magnetic body 511 and a length direction of the third sub-magnetic body 521 may be perpendicular to each other. A length direction of the second sub-magnetic body 512 and a length direction of the fourth sub-magnetic body 522 may be perpendicular to each other.

The first sub-magnetic body 511 and the second sub-magnetic body 512 may have a shape having a length in the second rotational axis (X-axis) direction. The third sub-magnetic body 521 and the fourth sub-magnetic body 522 may have a shape having a length in a direction, respectively perpendicular to the first rotational axis (Z-axis) and the second rotational axis (X-axis) (for example, a direction perpendicular to the incident surface of the reflective member 300).

Referring to FIG. 4, the holder 200 may be rotated around the second rotational axis (X-axis) to correct shaking.

Even if the power to the driving unit is turned off and the driving force is removed, attractive force may act between the first magnetic body portion 511 and the second magnetic body portion 520, and such attractive force may act as a return torque to return the holder 200 to an initial position thereof.

Referring to FIG. 5, the holder 200 may be rotated around the first rotational axis (Z-axis) to correct shaking.

When the holder 200 rotates around the first rotational axis (Z-axis), the same polarities of the first sub-magnetic body 511 and the third sub-magnetic body 521 become closer to each other, and the same polarities of the second sub-magnetic body 512 and the fourth sub-magnetic body 522 become closer to each other, so that strong repulsive force may act. Therefore, such repulsive force may act as a return torque to return the holder 200 to the initial position.

Referring to FIG. 6, when the holder 200 is to be rotated around an axis, perpendicular to both the first rotational axis (Z-axis) and the second rotational axis (X-axis), the same polarities of the first sub-magnetic body 511 and the third sub-magnetic body 521 become closer to each other, and the same polarities of the second sub-magnetic body 512 and the fourth sub-magnetic body 522 become closer to each other, so that strong repulsive force may act. Therefore, such repulsive force may act as a return torque to return the holder 200 to the initial position.

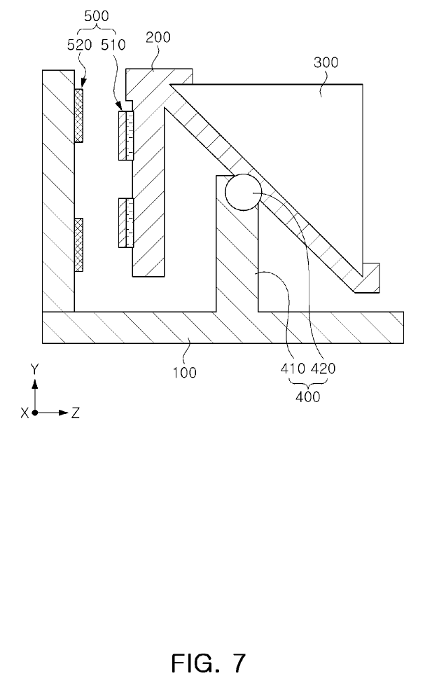

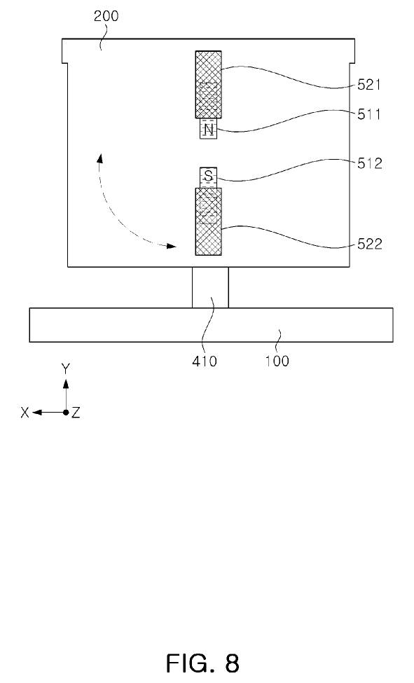

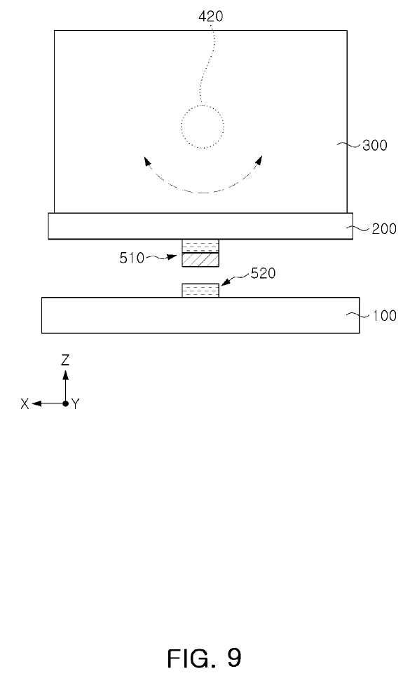

FIG. 7 is a side view of a reflection module according to another embodiment of the present disclosure, FIG. 8 is a rear view of a reflection module according to another embodiment of the present disclosure, and FIG. 9 is a plan view of a reflection module according to another embodiment of the present disclosure.

Referring to FIGS. 7-9, there is a difference in the configurations of a magnetic portion 500 from the previously described embodiments.

The magnetic portion 500 includes a first magnetic body portion 510 and a second magnetic body portion 520.

The first magnetic body portion 510 may be mounted on the holder 200, and the second magnetic body portion 520 may be mounted on the housing 100. The first magnetic body portion 510 and the second magnetic body portion 520 may face each other in a first rotational axis (Z-axis) direction.

The first magnetic body 510 includes a first sub-magnetic body 511 and a second sub-magnetic body 512. The first sub-magnetic body 511 and the second sub-magnetic body 512 may be disposed to be spaced apart in a direction perpendicular to both the first rotational axis (Z-axis) and the second rotational axis (X-axis) (e.g., a direction perpendicular to an incident surface of the reflective member 300).

The first sub-magnetic body 511 and the second sub-magnetic body 512 may respectively be magnets.

One surface of the first sub-magnetic body 511 and one surface of the second sub-magnetic body 512 may respectively be configured to have an N-pole or an S pole.

A polarity of the one surface of the first sub-magnetic body 511 and a polarity of the one surface of the second sub-magnetic body 512 may be opposite to each other.

The second magnetic body 520 includes a third sub-magnetic body 521 and a fourth sub-magnetic body 522. The third sub-magnetic body 521 and the fourth sub-magnetic body 522 may be disposed to be spaced apart in a direction perpendicular to both the first rotational axis (Z-axis) and the second rotational axis (X-axis) (e.g., a direction perpendicular to the incident surface of the reflective member 300).

The third sub-magnetic body 521 and the fourth sub-magnetic body 522 may be comprised of a material that can generate attractive force with respect to the first sub-magnetic body 511 and the second sub-magnetic body 512, respectively. For example, the third sub-magnetic body 521 and the fourth sub-magnetic body 522 may be a yoke, respectively.

At least a portion of one surface of the first sub-magnetic body 511 and at least a portion of one surface of the third sub-magnetic body 521 may face each other in the first rotational axis (Z-axis) direction. Attractive force acts between the first sub-magnetic body 511 and the third sub-magnetic body 521.

At least a portion of one surface of the second sub-magnetic body 512 and at least a portion of one surface of the fourth sub-magnetic body 522 may face each other in the first rotational axis (Z-axis) direction. Attractive force acts between the second sub-magnetic body 512 and the fourth sub-magnetic body 522.

A distance between the first sub-magnet body 511 and the second sub-magnet body 512 may be narrower than a distance between the third sub-magnet body 521 and the fourth sub-magnet body 522.

Referring to FIGS. 7-9, the holder 200 may be rotated with respect to the housing 100 to correct shaking.

Even if the power to the driving unit is turned off and the driving force is removed, attractive force acts between the first magnetic body portion 510 and the second magnetic body portion 520, and such attractive force may act as a return torque to return the holder 200 to the initial position.

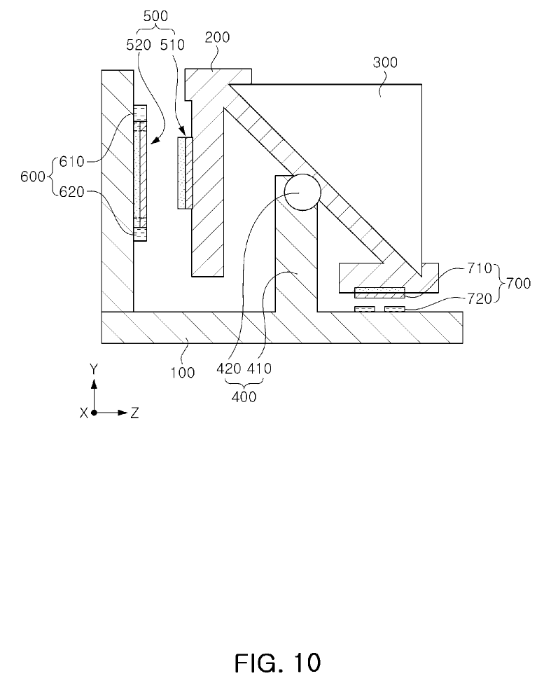

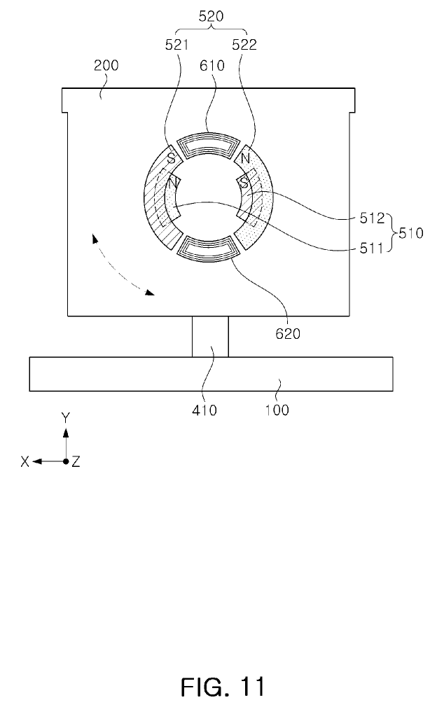

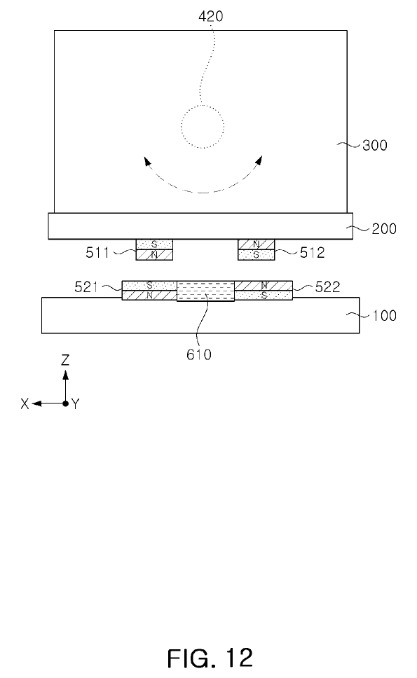

FIG. 10 is a side view of a reflection module, illustrating a driving unit of a reflection module according to an embodiment of the present disclosure, FIG. 11 is a rear view of FIGS. 10 and 12, is a plan view of FIG. 10.

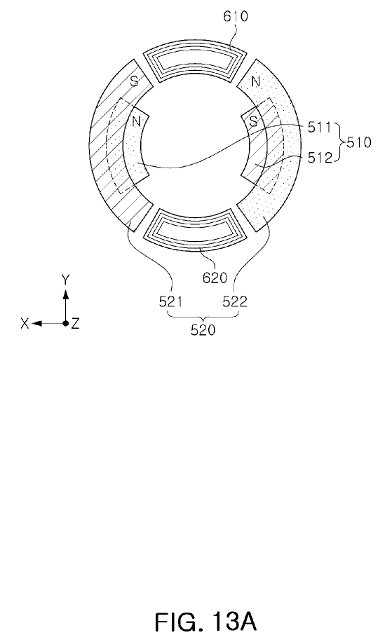

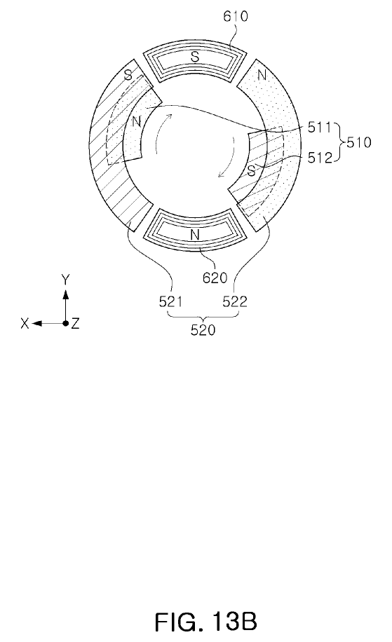

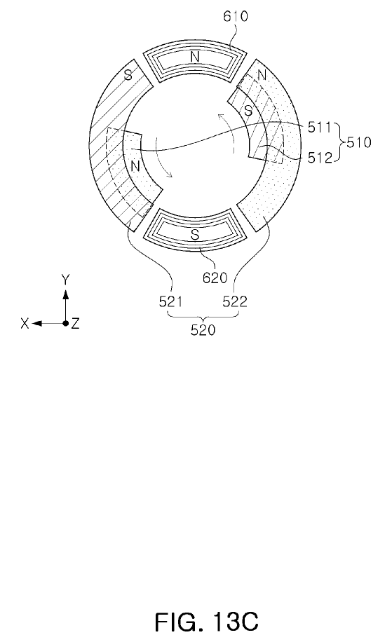

In addition, FIGS. 13A-13C are diagrams illustrating a driving unit of a reflection module according to an embodiment of the present disclosure.

Referring to FIGS. 10-13C, a reflection module according to an embodiment of the present disclosure includes a first driving unit 600 and a second driving unit 700.

A rotational direction of the holder 200 by the driving force of the first driving unit 600 and a rotational direction of the holder 200 by the driving force of the second driving unit 700 are different from each other.

The first driving unit 600 includes a plurality of coils. For example, the first driving unit 600 includes a first coil 610 and a second coil 620.

The first coil 610 and the second coil 620 may be mounted on the housing 100. The first coil 610 and the second coil 620 may be disposed to be spaced apart from each other.

A direction in which the first coil 610 and the second coil 620 are spaced apart from each other may be perpendicular to a direction in which a first sub-magnetic body 511 and a second sub-magnetic body 512 are spaced apart from each other.

The first coil 610 and the second coil 620 may be disposed to be spaced apart in a direction perpendicular to both a first rotational axis (Z-axis) and a second rotational axis (X-axis) (e.g., a direction perpendicular to an incident surface of the reflective member 300).

The first coil 610 and the second coil 620 may be wound to have a thickness in a direction toward the holder 200, respectively.

For example, the first coil 610 and the second coil 620 may be a wound coil or a pattern coil in which a metal layer is patterned on a substrate, respectively.

The first coil 610 may be disposed between one side of a third sub-magnetic body 521 and one side of a fourth sub-magnetic body 522, and the second coil 620 may be disposed between the other side of the third sub-magnetic body 521 and the other side of the fourth sub-magnetic body 522.

The first coil 610 and the second coil 620 respectively have an inner surface and an outer surface, and the inner surface and the outer surface may respectively have curved shapes. Here, the inner surface may be a surface facing a center of rotation of the holder 200 when viewed in the first rotational axis (Z-axis) direction, and the outer surface may be an opposite surface of the inner surface. In addition, the inner surface of the first coil 610 and the inner surface of the second coil 620 may mean surfaces, adjacent to each other.

When current flows through a first coil 610 and a second coil 620, respectively, the first coil 610 and the second coil 620 may function as electromagnets.

For example, when power is supplied to the first coil 610, a magnetic field may be formed around the first coil 610. In this case, one surface of the first coil 610 (a side facing the holder 200) and the other side of the first coil 610 (an opposite side of the one side) may have different polarities. In addition, polarities of the one side and the other side of the first coil 610 may be changed by controlling a direction of the current flowing in the first coil 610.

In addition, when power is supplied to the second coil 620, a magnetic field may be formed around the second coil 620. In this case, one side of the second coil 620 (a side facing the holder 200) and the other side of the second coil 620 (an opposite side of the one side) may have different polarities, respectively. In addition, the polarities of the one side and the other side of the second coil 620 may be changed by controlling the direction of the current flowing in the second coil 620.

Referring to FIGS. 13A-13C, when one side of the first coil 610 has a polarity opposite to that of the first sub-magnetic body 511, attractive force may act between the one side of the first coil 610 and the first sub-magnetic body 511. When one side of the second coil 620 has a polarity opposite to that of the second sub-magnetic body 512, attractive force may act between the one side of the second coil 620 and the second sub-magnetic body 512.

Accordingly, the holder 200 may be rotated relatively, with respect to the housing 100.

Meanwhile, referring to FIG. 10, the second driving unit 700 may include a driving magnet 710 and a third coil 720.

The driving magnet 710 may be mounted on the holder 200, and the third coil 720 may be fixed to the housing 100. The driving magnet 710 and the third coil 720 may face each other in a direction perpendicular to the incident surface of the reflective member 300.

Therefore, the holder 200 may be rotated relatively, with respect to the housing 100 by electromagnetic force between the driving magnet 710 and the coil.

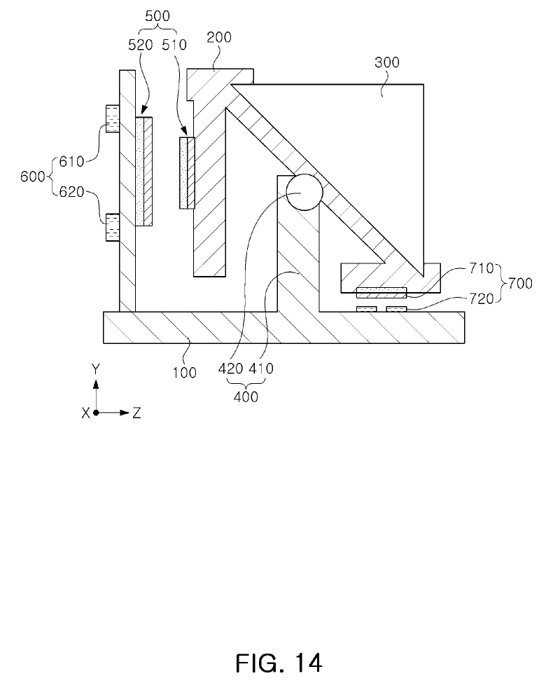

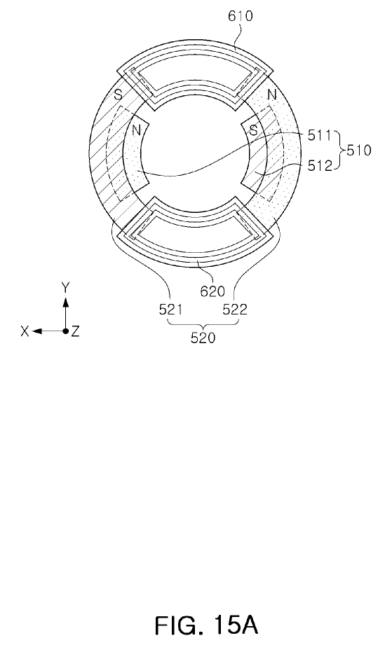

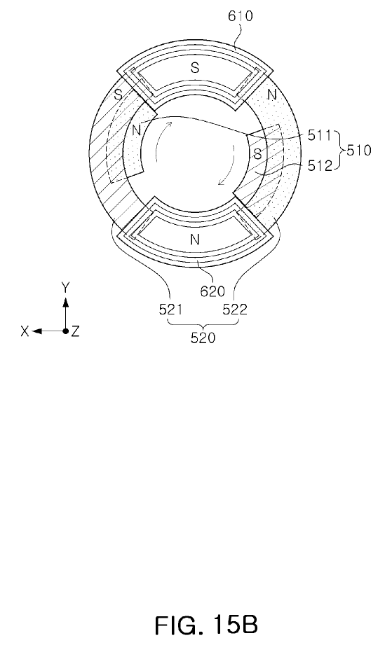

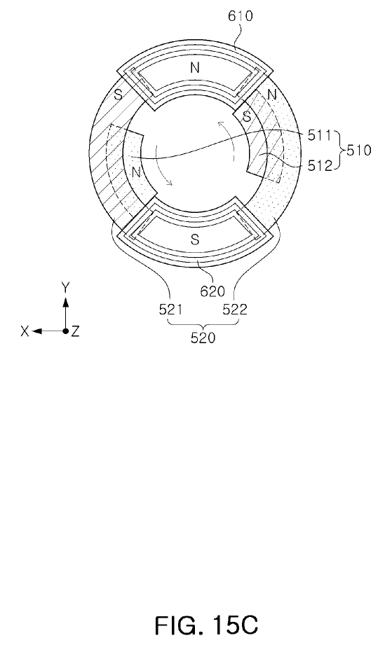

FIG. 14 is a side view of a reflection module illustrating a modified example of a first driving unit 600, and FIGS. 15A-15C are diagrams illustrating a modified example of the first driving unit.

Referring to FIG. 14, a second magnetic body portion 520 may be disposed on an inner surface of the housing 100, and a first driving unit 600 may be disposed on an outer surface of the housing 100.

Compared to the embodiment of FIG. 10, since a greater mounting space of the first driving unit 600 may be secured, a design freedom of the first coil 610 and the second coil 620 may be improved.

As set forth above, according to one or more embodiments of the present disclosure, a reflection module may rotate a reflective member with a simple structure to correct shaking, and may adjust a position of the reflective member, even when power is not supplied.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflection module, comprising:
a housing;
a holder rotatably disposed with respect to the housing;
a reflective member fixed to the holder;
a support portion disposed between the housing and the holder, and supporting the holder so that the holder is rotatable in a plurality of directions;
a first magnetic body portion disposed in the holder, and comprising a first magnet and a second magnet, disposed to be spaced apart from each other; and
a second magnetic body portion disposed in the housing, and comprising a third magnet and a fourth magnet, disposed to be spaced apart from each other,
wherein attractive force acts between the first magnet and the third magnet, and between the second magnet and the fourth magnet, respectively,
wherein a polarity of one surface of the first magnet and a polarity of one surface of the second magnet are opposite to each other, and
wherein a polarity of one surface of the third magnet and a polarity of one surface of the fourth magnet are opposite to each other.

2. The reflection module of claim 1, wherein a direction in which the first magnet and the second magnet are spaced apart from each other and a direction in which the third magnet and the fourth magnet are spaced apart from each other are the same.

3. The reflection module of claim 1, wherein a distance between a center of the first magnet and a center of the second magnet is less than a distance between a center of the third magnet and a center of the fourth magnet.

4. The reflection module of claim 1, wherein a portion of the first magnetic body portion and a portion of the second magnetic body portion face each other in one direction, and
wherein when viewed in the one direction, the first magnetic body portion is closer to the support portion than the second magnetic body portion.

5. The reflection module of claim 1, wherein a portion of the one surface of the first magnet and a portion of the one surface of the third magnet face each other, and
wherein a portion of the one surface of the second magnet and a portion of the one surface of the fourth magnet face each other.

6. The reflection module of claim 1, wherein the third magnet is disposed to overlap less than half a width of the one surface of the first magnet in one direction, and
wherein the fourth magnet is disposed to overlap less than half the width of the one surface of the second magnet in the one direction.

7. The reflection module of claim 1, wherein the polarity of the one surface of the first magnet and the polarity of the one surface of the fourth magnet are the same polarities, and
wherein the polarity of the one surface of the second magnet and the polarity of the one surface of the third magnet are the same polarities.

8. The reflection module of claim 1, wherein the first to fourth magnets respectively have curved inner and outer surfaces.

9. The reflection module of claim 8, wherein a length of the third magnet is longer than a length of the first magnet, and
wherein a length of the fourth magnet is longer than a length of the second magnet.

10. The reflection module of claim 8, wherein an area of the one surface of the third magnet is greater than an area of the one surface of the first magnet, and
wherein an area of the one surface of the fourth magnet is greater than an area of the one surface of the second magnet.

11. The reflection module of claim 8, wherein the inner surface of the first magnet, the outer surface of the first magnet, the inner surface of the third magnet, and the outer surface of the third magnet are portions of concentric circles when viewed in one direction, and
wherein the inner surface of the second magnet, the outer surface of the second magnet, the inner surface of the fourth magnet, and the outer surface of the fourth magnet are portions of concentric circles when viewed in the one direction.

12. The reflection module of claim 1, further comprising:
a first driving unit disposed in the housing, and comprising a first coil and a second coil,
wherein a direction in which the first coil and the second coil are spaced apart from each other is perpendicular to a direction in which the third magnet and the fourth magnet are spaced apart from each other.

13. The reflection module of claim 12, wherein the first coil and the second coil are wound to have a thickness in a direction toward the holder, respectively.

14. The reflection module of claim 12, wherein the third magnet and the fourth magnet are respectively disposed on an inner surface of the housing, and
wherein the first coil and the second coil are respectively disposed on the inner surface of the housing.

15. The reflection module of claim 14, wherein the first coil is disposed between one side of the third magnet and one side of the fourth magnet, and
wherein the second coil is disposed between the other side of the third magnet and the other side of the fourth magnet.

16. The reflection module of claim 12, wherein the first coil and the second coil respectively have curved inner and outer surfaces.
